(19) United States
(12) Patent Application Publication
(10) Pub. No.: US 2019/0293898 A1
(43) Pub. Date: Sep. 26, 2019

(54) INFRARED LENS UNIT

(71) Applicant: Sumitomo Electric Industries, Ltd., Osaka-shi (JP)

(72) Inventors: Masato Hasegawa, Osaka-shi (JP); Akinori Kahara, Osaka-shi (JP); Ryota Yamaguchi, Osaka-shi (JP)

(21) Appl. No.: 16/086,048

(22) PCT Filed: Mar. 17, 2017
(86) PCT No.: PCT/JP2017/010954

§ 371 Date: Sep. 18, 2018

(30) Foreign Application Priority Data
Mar. 18, 2016 (JP) 2016-056291

(51) Int. Cl. G02B 7/02; G02B 13/14; G03B 17/08; G03B 17/56; H04N 5/225

(52) U.S. Cl. CPC G02B 7/02; G02B 13/14; H04N 5/2254; G03B 17/56; H04N 5/2252; G03B 17/08

(57) ABSTRACT

An infrared lens unit of the present invention includes a lens barrel having, on the distal end side thereof, an engaging part having a large inner diameter, an infrared lens that is fitted in the engaging part, and a cap that engages with the outside of the distal end part of the lens barrel, thereby fixing the infrared lens in the engaging part. The infrared lens unit includes a waterproof structure that seals between the infrared lens and the cap.

### TECHNICAL FIELD

The present invention relates to an infrared lens unit.

This application claims the priority based on Japanese Patent Application No. 2016-56291 filed on Mar. 18, 2016, the entire contents of which are incorporated herein by reference.

### BACKGROUND ART

An infrared camera including an infrared lens unit having an infrared lens and an infrared imaging device and capturing an infrared image to generate image data has been used for various purposes.

In recent years, in order to improve the performance of an infrared camera, it is required to increase the infrared transmittance of an optical member such as an infrared lens disposed on the optical path. On the other hand, as a material having a relatively high infrared transmittance used for an optical member of an infrared camera, for example, a dielectric such as zinc sulfide, zinc selenide, magnesium fluoride, sodium chloride, potassium chloride, lithium fluoride, silicon oxide, calcium fluoride, or barium fluoride, or a semiconductor such as silicon or germanium is used.

Also, some infrared cameras are used outdoors. Infrared cameras used outdoors are required to have cold resistance, heat resistance, and waterproofness.

Therefore, in order to impart waterproofness to an infrared camera, it has been proposed to dispose a camera body including an infrared lens unit, an imaging device, and other constituent elements in a waterproof case that is hermetically sealed (see Japanese Unexamined Patent Application Publication No. 2001-57642).

### CITATION LIST

### Patent Literature

PTL 1: Japanese Unexamined Patent Application Publication No. 2001-57642

### SUMMARY OF INVENTION

In an aspect of the present invention, an infrared lens unit includes a lens barrel having, on the distal end side thereof, an engaging part having a large inner diameter, an infrared lens that is fitted in the engaging part, and a cap that engages with the outside of the distal end part of the lens barrel, thereby fixing the infrared lens in the engaging part. The infrared lens unit includes a waterproof structure that seals between the infrared lens and the cap.

### BRIEF DESCRIPTION OF DRAWINGS

FIG. 1 is a schematic cross-sectional view showing an infrared lens unit according to one embodiment of the present invention.

FIG. 2 is a schematic cross-sectional view showing an infrared lens unit according to an embodiment of the present invention different from FIG. 1.

### DESCRIPTION OF EMBODIMENTS

### Problems to be Solved by Present Invention

When the constituent elements of the infrared camera are housed in a waterproof case as disclosed in the above gazette, it is necessary to provide the case with a window for passing infrared light from the object and to seal the window with a plate material having high infrared transmittance.

However, infrared transmitting materials having high infrared transmittance as described above are relatively expensive. Therefore, using such an infrared transmitting material for the plate material for sealing the window of the waterproof case is a factor in increasing the price of the infrared camera.

Even in the material having high infrared transmittance, the loss of infrared rays cannot be ignored, and there is a disadvantage that the performance of the infrared camera deteriorates by providing the waterproof case.

On the other hand, if there is an infrared lens unit having waterproofness, an infrared camera that has waterproofness and a relatively small loss of infrared rays can be constituted by disposing the infrared lens unit in the opening of the waterproof case and sealing the opening of the case with the infrared lens unit.

The present invention has been made based on the above-mentioned circumstances, and an object of the present invention is to provide an infrared lens unit that can relatively easily constitute an infrared camera having small loss and waterproofness.

### Advantageous Effects of Present Invention

The infrared lens unit according to one embodiment of the present invention can relatively easily constitute an infrared camera having small loss and waterproofness.

### DESCRIPTION OF EMBODIMENT OF PRESENT INVENTION

In an aspect of the present invention, an infrared lens unit includes a lens barrel having, on the distal end side thereof, an engaging part having a large inner diameter, an infrared lens that is fitted in the engaging part, and a cap that engages with the outside of the distal end part of the lens barrel, thereby fixing the infrared lens in the engaging part. The infrared lens unit includes a waterproof structure that seals between the infrared lens and the cap.

Since the infrared lens unit has a waterproof structure that seals between the infrared lens and the cap, and on the other hand, it is easy to seal between the cap and the lens barrel, waterproofness can be relatively easily imparted to the infrared lens unit. For this reason, by airtightly attaching the lens barrel of the infrared lens unit to the opening of the waterproof case to ensure the seal between the cap and the lens barrel, the opening of the case can be airtightly sealed. Therefore, the infrared lens unit can relatively easily constitute an infrared camera having small loss and waterproofness.

The cap is preferably formed of a metal having a passivation film. By forming the cap out of a metal having a passivation film as described above, the weather resistance of the cap and thus the infrared lens unit is improved.

The waterproof structure preferably has a structure in which the cap directly contacts the infrared lens and tensile stress in the optical axis direction is generated in the engaging part by screwing the cap to the lens barrel, and the tensile stress acting on the engaging part at 20° C. is preferably 20% or more and 50% or less of the tensile yield stress of the engaging part. Since, as described above, the waterproof structure has a structure in which the cap directly contacts the infrared lens and tensile stress in the optical axis direction is generated in the engaging part by screwing the cap to the lens barrel, and the tensile stress acting on the engaging part at 20° C. is within the above range, the lens barrel has a certain range of elongation strain at room temperature. Therefore, when the temperature rises and the lens barrel extends, since the elongation strain decreases, it is possible to maintain the state where the cap directly contacts the infrared lens. Conversely, when the temperature is lowered and the lens barrel contracts, the elongation strain further increases, but it does not readily reach the tensile yield stress, so it does not lead to fracture. That is, in the infrared lens unit, by setting the tensile stress acting on the engaging part at 20° C. within the above range, the airtightness between the cap and the infrared lens can be maintained over a relatively wide temperature range in both temperature decrease from ordinary temperature and temperature rise from ordinary temperature, and therefore the waterproofness is maintained.

The waterproof structure preferably include an annular elastic member interposed between the infrared lens and the cap. Since, as described above, the waterproof structure includes an annular elastic member interposed between the infrared lens and the cap, the elastic member absorbs expansion and contraction of the lens barrel due to temperature change, and the airtightness between the cap and the infrared lens can thereby be secured.

The maximum thickness of the elastic member under no load is preferably 0.1 times or more and 0.3 times or less the average distance in the optical axis direction from the image-side end of the engaging part to the elastic member. Since the maximum thickness of the elastic member under no load is set within the above range, the infrared lens unit absorbs the difference in the amount of expansion and contraction due to the difference in linear expansion coefficient between a general metal and an infrared transmitting material, and waterproofness can be maintained over a relatively wide temperature range.

Here, the “distal end side” means the object side in the optical axis direction. “Tensile yield stress” means upper tensile yield stress measured in conformity with JIS-Z2241 (2011).

### DETAILS OF EMBODIMENTS OF PRESENT INVENTION

Hereinafter, embodiments of the infrared lens unit according to the present invention will be described in detail with reference to the drawings.

### First Embodiment

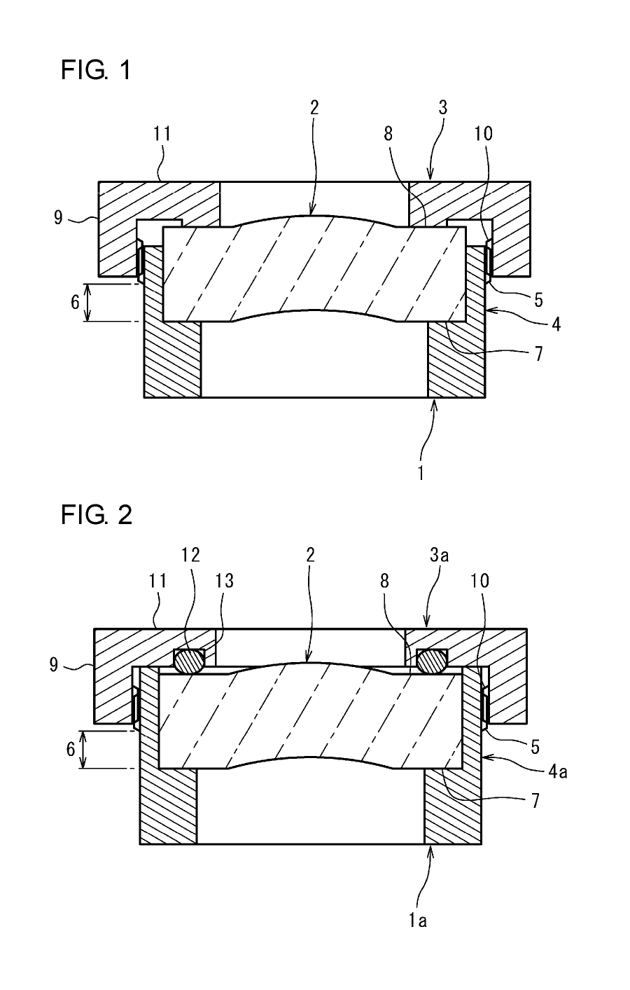

The infrared lens unit shown in FIG. 1 includes a lens barrel 1, an infrared lens 2, and a cap 3. The infrared lens unit has a waterproof structure that seals between the infrared lens 2 and the cap 3.

### <Lens Barrel>

The lens barrel 1 is formed in a tubular shape and has, on the distal end side thereof, an engaging part 4 the inner diameter of which is larger than that of the other part and in which the infrared lens 2 is fitted. Further, the lens barrel 1 has, on the outside of the distal end part thereof, an external thread 5 to which the cap 3 is screwed. More specifically, the external thread 5 is formed on the outside of the distal end side of the engaging part 4, and the cap 3 may not be screwed to the rear end side of the engaging part 4.

As the material of the lens barrel 1, a metal having relatively high strength and excellent workability can be used. Metals forming the lens barrel 1 include aluminum, aluminum alloy, and stainless steel. In particular, the lens barrel 1 is preferably formed of a metal having a passivation film. Specific examples of the metal having a passivation film include aluminum subjected to alumite treatment (anodizing treatment) on its surface. By forming the lens barrel 1 out of a metal having a passivation film, the weather resistance of the lens barrel 1 can be improved.

### (Engaging Part)

The engaging part 4 is a part that receives the infrared lens 2 and mainly generates elongation strain by pressing the cap 3 against the infrared lens 2. In the case of this embodiment, an elastic part 6 of the engaging part 4, in which the external thread 5 is not formed, has the smallest cross-sectional area, and expands and contracts relatively large in the optical axis direction. Further, when a structure for engaging with an external structure such as a waterproof case is provided on the outside of the rear end side of the engaging part 4, and the thickness in the radial direction of the engaging part 4 substantially increases, this part is excluded and a part having a small thickness is regarded as the elastic part 6. That is, the elastic part 6 is a part where the tensile stress is largest in the engaging part 4, and the tensile stress of the elastic part 6 is interpreted as the tensile stress acting on the engaging part 4.

The lower limit of the maximum thickness of the elastic part 6 is preferably 3%, more preferably 5% of the average inner diameter of the elastic part 6. On the other hand, the upper limit of the maximum thickness of the elastic part 6 is preferably 20%, more preferably 15% of the average inner diameter of the elastic part. When the maximum thickness of the elastic part 6 is less than the lower limit, the elastic part 6 may be broken due to variations in tightening torque of the cap 3 or externally applied force. Conversely, when the maximum thickness of the elastic part 6 exceeds the upper limit, there is a possibility that application of elongation strain to the elastic part 6 is difficult.

### <Infrared Lens>

The infrared lens 2 is formed so as to refract and focus the infrared light from the object. Further, the infrared lens 2 has a positioning end face 7 that contacts a step at the rear end of the engaging part 4, and a seal end face 8 that contacts the cap 3.

It is preferable that the average distance in the optical axis direction between the positioning end face 7 and the seal end face 8 of the infrared lens 2 be larger than the average length in the optical axis direction of the engaging part 4 of the lens barrel 1. Thereby, it becomes easy to bring the infrared lens 2 and the cap 3 into pressure contact with each other in an airtight manner and apply a tensile stress to the elastic part 6.

As the main component of the infrared lens 2, any material that transmits infrared rays may be used. For example, a dielectric such as zinc sulfide (ZnS), zinc selenide (ZnSe), magnesium fluoride (MgF₂), sodium chloride (NaCl), potassium chloride (KCl), lithium fluoride (LiF), silicon oxide (SiO₂), calcium fluoride (CaF₂), or barium fluoride (BaF₂), or a semiconductor such as silicon or germanium can be used. Among them, zinc sulfide, which has a relatively high infrared transmittance, is preferable as the main component of the infrared lens 2. “Main component” means a component having the largest mass content, preferably a component having a mass content of 95% by mass or more.

The material of the infrared lens 2 having such a main component generally has a smaller linear expansion coefficient (thermal expansion coefficient) than metal or resin. That is, when the temperature rises, the lens barrel 1 thermally expands more than the infrared lens 2.

In the case where the infrared lens 2 contains zinc sulfide as the main component, the infrared lens 2 may be formed by chemical vapor deposition (CVD), but by forming it by sintering zinc sulfide powder, which is relatively inexpensive, the manufacturing cost can be suppressed. That is, it is preferable that the infrared lens 2 be a sintered body of a material containing zinc sulfide as the main component. In other words, as the main component of the infrared lens 2, a sintered body of zinc sulfide is preferable.

The infrared lens 2 that is mainly composed of a sintered body of zinc sulfide can be formed by a method including a step of molding a zinc sulfide powder, a step of pre-sintering the molded body, and a step of pressure-sintering the pre-sintered body.

As the zinc sulfide powder forming a sintered body of zinc sulfide, it is preferable to use one having an average particle diameter of 1 μm or more and 3 μm or less and a purity of 95% by mass or more. Such a zinc sulfide powder can be obtained by a known powder synthesis method such as a coprecipitation method. The “average particle diameter” is the particle diameter at which the volume integrated value is 50% in the particle diameter distribution measured by the laser diffraction method.

In the molding step, a compact having a rough shape conforming to the optical component to be finally obtained is formed by press molding using a mold. The mold is formed of a hard material such as cemented carbide or tool steel. Further, this molding step can be carried out using, for example, a uniaxial pressing machine.

In the pre-sintering step, the molded body produced in the molding step is heated, for example, under a vacuum atmosphere of 30 Pa or less or under an inert atmosphere such as nitrogen gas at atmospheric pressure. The pre-sintering temperature can be 500° C. or more and 1000° C. or less, and the pre-sintering time (holding time of the pre-sintering temperature) can be 0.5 hour or more and 15 hours or less. The pre-sintered body obtained in this pre-sintering step has a relative density of 55% or more and 80% or less.

In the pressure-sintering step, a sintered body having a desired shape is obtained by heating the pre-sintered body while pressing it with a press mold. Specifically, as the press mold, for example, a pair of molds (upper mold and lower mold) formed of glassy carbon and having a mirror-polished restrained surface (cavity) can be used. The pressure-sintering temperature is preferably 550° C. or more and 1200° C. or less. The sintering pressure is preferably 10 MPa or more and 300 MPa or less. The sintering time is preferably 1 minute or more and 60 minutes or less.

The sintered body obtained in this pressure-sintering step may be used as it is as the infrared lens 2, but finishing processing such as polishing of the incident surface and the emitting surface may be performed as required.

Further, the infrared lens 2 may have, on the object-side surface thereof, various functional layers, such as a protective layer for improving scratch resistance, a sealing layer for preventing ingress of water molecules, and an antireflection layer for preventing reflection of light in the use wavelength band.

### <Cap>

The cap 3 engages with the outside of the distal end part of the lens barrel 2, thereby fixing the infrared lens 2 in the engaging part 4. The cap 3 includes a cylindrical tube part 9 disposed outside the lens barrel 1, an internal thread 10 provided in the inner periphery of the tube part 9 and screwed to the external thread 5 of the lens barrel 1, and a flange part 11 that extends radially inward from the upper end of the tube part 9 and that is pressed against the seal end face 8 of the infrared lens 2 in the optical axis direction.

By screwing the internal thread 10 onto the external thread 5 and tightening it, the cap 3 presses the flange part 11 against the seal end face 8 of the infrared lens 2 to seal the gap with the infrared lens 2. That is, the infrared lens unit has, as a waterproof structure that seals between the infrared lens 2 and the cap 3, a structure in which the flange part 11 of the cap 3 directly contacts the infrared lens 2 and tensile stress in the optical axis direction is generated in the engaging part 4 by screwing the cap 3 to the lens barrel 1.

The tightening torque of the cap 3 is selected such that the tensile stress in the optical axis direction acting on the elastic part 6 of the engaging part 4 by the axial force generated in the lens barrel 1 is within a certain range with respect to the tensile yield stress of the elastic part 6. Thereby, the elastic part always has elongation strain within the elastic range, and when the temperature changes, the dimensional difference caused by the difference in thermal expansion coefficient in the optical axis direction between the engaging part 4 and the infrared lens 2 can be absorbed. The axial force acting on the elastic part 6 of the engaging part 4 is proportional to the tightening torque of the cap 3, and its proportionality constant is approximately determined by the shapes of the external thread 5 and the internal thread 10 (thread angle, lead angle, effective diameter, and so forth).

The lower limit of the tensile stress acting on the elastic part 6 of the engaging part 4 at 20° C. is preferably 20%, more preferably 25% of the tensile yield stress of the engaging part 4. On the other hand, the upper limit of the tensile stress acting on the elastic part 6 of the engaging part 4 at 20° C. is preferably 50%, more preferably 45% of the tensile yield stress of the engaging part 4. When the tensile stress acting on the elastic part 6 of the engaging part 4 at 20° C. is less than the lower limit, a gap may be generated between the infrared lens 2 and the cap 3 when the engaging part 4 thermally expands due to the temperature rise. Conversely, when the tensile stress acting on the elastic part 6 of the engaging part 4 at 20° C. exceeds the upper limit, the tensile stress of the elastic part 6 increases to exceed the tensile yield stress when the engaging part 4 contracts due to the temperature decrease, and thereby the elastic part 6 may be deformed or broken.

As the material of the cap 3, a metal having relatively high strength and excellent workability can be used. Metals forming the cap 3 include aluminum, aluminum alloy, and stainless steel. In particular, the cap 3 is preferably formed of a metal having a passivation film. Specific examples of the metal having a passivation film include aluminum subjected to alumite treatment (anodizing treatment) on its surface. By forming the cap 3 out of a metal having a passivation film, the weather resistance of the cap 3 can be improved.

The thickness and the like of the cap 3 are selected such that the deformation of the cap 3 caused by tightening of the cap 3 is sufficiently smaller than the expansion and contraction strain of the engaging part 4 of the lens barrel 1.

### <Advantages>

Since the infrared lens unit has a waterproof structure that seals between the cap 3 and the infrared lens 2 as described above, water does not enter the inside of the lens barrel 1 through the gap between the cap 3 and the infrared lens 2. Further, since the gap between the lens barrel 1 and the cap 3 can be easily sealed between the external thread 5 and the internal thread 10, water is prevented from entering the inside of the lens barrel 1 through the gap between the lens barrel 1 and the cap 3. Therefore, by airtightly attaching the lens barrel 1 of the infrared lens unit to the opening of the waterproof case, the opening of the waterproof case can be airtightly sealed. Therefore, by using the infrared lens unit, an infrared camera having small loss and waterproofness can be relatively easily constituted.

In particular, since the infrared lens unit has, as a waterproof structure, a configuration in which the cap 3 is pressed against the infrared lens 2 by the elastic force of the engaging part 4 of the lens barrel 1, and the tensile stress of the engaging part 4 at 20° C. (room temperature) is set within a predetermined range, waterproofness from a low temperature environment to a high temperature environment, for example, within the range of −40° C. or more and 85° C. or less is ensured.

### Second Embodiment

The infrared lens unit in FIG. 2 includes a lens barrel la, an infrared lens 2, and a cap 3a. The infrared lens unit further includes, as a waterproof structure that seals between the infrared lens 2 and the cap 3a, an annular elastic member 12 interposed between the infrared lens 2 and the cap 3a. The configuration of the infrared lens 2 in the infrared lens unit in FIG. 2 can be the same as the configuration of the infrared lens 2 in the infrared lens unit in FIG. 1.

### <Lens Barrel>

The configuration of the lens barrel la in the infrared lens unit of FIG. 2 can be the same as the configuration of the lens barrel 1 in the infrared lens unit of FIG. 1 except that the length in the optical axis direction of the engaging part 4a whose inner diameter is larger than the other part is larger than the length in the optical axis direction of the peripheral surface of the infrared lens 2.

### <Cap>

The configuration of the cap 3a in the infrared lens unit of FIG. 2 can be the same as the configuration of the cap 3 of the infrared lens unit of FIG. 1, except that the cap 3a has an annular groove 13 in which the elastic member 12 is fitted.

In the infrared lens unit of FIG. 2, the length in the optical axis direction of the engaging part 4a is greater than the length in the optical axis direction of the peripheral surface of the infrared lens 2, and therefore the flange part 11 of the cap 3a contacts the object-side end face of the engaging part 4a. Therefore, the flange part 11 of the cap 3a does not directly contact the infrared lens 2, and the gap between the infrared lens 2 and the flange part 11 is sealed by the elastic member 12. Therefore, in the infrared lens unit of FIG. 2, the dimensional difference between the lens barrel 1 and the infrared lens 2 is absorbed by the deformation of the elastic member 12 without applying a large tensile stress to the engaging part 4a of the lens barrel 1.

### <Elastic Member>

As the elastic member 12, for example, an O-ring, one obtained by annularly cutting out a sheet material, or the like can be used. That is, the cross-sectional shape of the elastic member 12 is not particularly limited. As the O-ring, for example, one in conformity with JIS-B2401 (2012) can be used.

As the main component of the elastic member 12, for example, nitrile rubber (NBR), fluororubber (FKM), fluorosilicone rubber (FVMQ), ethylene-propylene rubber (EPDM), styrene-butadiene rubber (SBR), silicone rubber (VMQ), acrylic rubber (ACM), and hydrogenated nitrile rubber (HNBR) can be used, among which silicone rubber, fluororubber, acrylic rubber, and hydrogenated nitrile rubber, which are excellent in heat resistance, are preferable, and silicone rubber, which is excellent in cold resistance, is particularly preferable.

The lower limit of the maximum thickness in the optical axis direction of the elastic member 12 under no load is preferably 0.05 times, more preferably 0.1 times the average distance in the optical axis direction from the image-side end of the engaging part 4a to the elastic member 12 (the average distance in the optical axis direction between the positioning end face 7 and the seal end face 8 of the infrared lens 2). On the other hand, the upper limit of the maximum thickness of the elastic member 12 under no load is preferably 0.4 times, more preferably 0.3 times the average distance in the optical axis direction from the image-side end of the engaging part 4a to the elastic member 12. When the maximum thickness of the elastic member 12 under no load is less than the lower limit, the elastic deformability may be insufficient and the sealing between the infrared lens 2 and the cap 3a may be insufficient. Conversely, when the maximum thickness of the elastic member 12 under no load exceeds the upper limit, the lens unit may be unnecessarily large in the optical axis direction.

### <Advantages>

In the lens unit, since the difference between the amount of expansion and contraction in the optical axis direction of the lens barrel 1 and the amount of expansion and contraction in the optical axis direction of the infrared lens 2 due to the temperature change is absorbs by the elastic member 12, the airtightness between the infrared lens 2 and the cap 3a can be maintained over a relatively wide temperature range.

### Other Embodiments

It should be considered that embodiments disclosed above are examples in all respects and are not restrictive. The scope of the present invention is not limited to the configurations of the above embodiments but is defined by the claims, and it is intended that all modifications within meaning and scope equivalent to the claims are included.

In the lens unit, the waterproof structure between the infrared lens and the cap may be different from those in the above embodiments.

The cap of the lens unit may be airtightly fixed to the opening of the waterproof case. When the cap is fixed to the waterproof case in this manner, waterproofness between the lens barrel and the cap is not required.

1. An infrared lens unit comprising:
a lens barrel having, on a distal end side thereof, an engaging part having an inner diameter larger than an inner diameter of the other part in the lens barrel;
an infrared lens that is fitted in the engaging part; and
a cap that engages with an outside of the distal end part of the lens barrel, thereby fixing the infrared lens in the engaging part,
the infrared lens unit comprising a waterproof structure that seals between the infrared lens and the cap.

2. The infrared lens unit according to claim 1, wherein the cap is formed of a metal having a passivation film.

3. The infrared lens unit according to claim 1,
wherein the waterproof structure has a structure in which the cap directly contacts the infrared lens and tensile stress in an optical axis direction is generated in the engaging part by screwing the cap to the lens barrel, and
wherein the tensile stress acting on the engaging part at 20° C. is 20% or more and 50% or less of a tensile yield stress of the engaging part.

4. The infrared lens unit according to claim 1, wherein the waterproof structure includes an annular elastic member interposed between the infrared lens and the cap.

5. The infrared lens unit according to claim 4, wherein a maximum thickness of the elastic member under no load is 0.1 times or more and 0.3 times or less an average distance in an optical axis direction from an image-side end of the engaging part to the elastic member.
